(19) United States
(12) Patent Application Publication
(10) Pub. No.: US 2013/0100035 A1
(43) Pub. Date: Apr. 25, 2013

(54) Graphical User Interface Interaction Using Secondary Touch Input Device

(71) Applicants: Matthew Nicholas Papakipos, Palo Alto, CA (US); Matthew Cahill, San Francisco, CA (US)

(72) Inventors: Matthew Nicholas Papakipos, Palo Alto, CA (US); Matthew Cahill, San Francisco, CA (US)

(21) Appl. No.: 13/276,902

(22) Filed: Oct. 19, 2011

(51) Int. Cl. G06F 3/041

(52) U.S. Cl. 345/173

(57) ABSTRACT

In one embodiment, a user of a mobile device comprising a front-side display and a back-side touch surface selects a control key mode for an application user interface displayed in the front-side display by using touch input on the back-side touch surface.

### TECHNICAL FIELD

The present disclosure relates generally to user interface interaction using touch inputs, and, more particularly, to selecting an operational mode corresponding to a control key for an application user interface displayed in a mobile device's front-side display by using touch input on the mobile device's secondary touch surface.

### BACKGROUND

A touchpad is an input device including a surface that detects touch-based inputs. A touch screen is an electronic visual display that detects the presence and location of user touch inputs. Mobile devices (such as a mobile phone, a tablet computer, and a laptop computer) often incorporate a touch screen or a touchpad to facilitate user interactions with application programs running on the mobile device.

A keyboard of a computing device often comprises one or more modifier keys or control keys (e.g., Shift key, Control key, etc.) When a user selects a control key, a user interface of an application hosted by the computing device, or an application user interface, can process the user's input partly based on the selected control key.

### SUMMARY

Particular embodiments relate to selecting an operational mode corresponding to a control key for an application user interface displayed in a mobile device's front-side display by using touch input on the mobile device's secondary touch surface. These and other features, aspects, and advantages of the disclosure are described in more detail below in the detailed description and in conjunction with the following figures.

### BRIEF DESCRIPTION OF THE DRAWINGS

FIG. 1 illustrates an example processing stack of a mobile device.

FIG. 2 illustrates an example mobile device.

FIGS. 3A-3E illustrate examples of selecting a control key mode using touch input.

FIGS. 4A-4E illustrate example touch gestures for selecting control key modes.

FIGS. 5A-5B illustrate example touch gestures for selecting control key modes.

FIG. 6 illustrates an example mobile device platform.

### DETAILED DESCRIPTION

The invention is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

A touchpad is an input device including a surface that detects touch-based inputs of users. Similarly, a touch screen is an electronic visual display surface that detects the presence and location of user touch inputs. So-called dual touch or multi-touch displays or touchpads refer to devices that can identify the presence, location and movement of more than one touch input, such as two- or three-finger touches. A system incorporating one or more touch-based input devices may monitor one or more touch-sensitive surfaces for touch or near touch inputs from a user. When one or more such user inputs occur, the system may determine the distinct area(s) of contact and identify the nature of the touch or near touch input(s) via geometric features and geometric arrangements (e.g., location, movement), and determine if they correspond to various touch events or gestures (e.g., tap, drag, swipe, pinch).

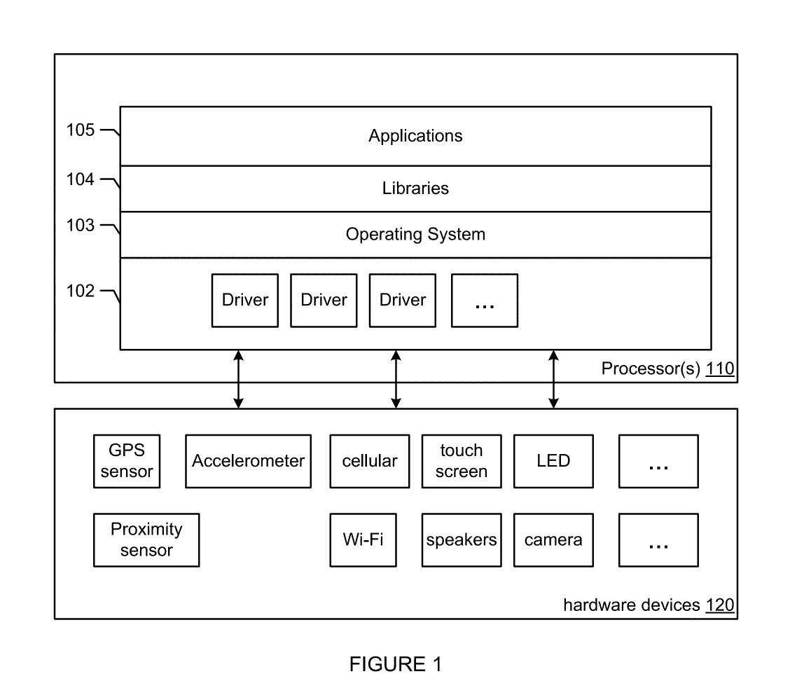

Recognition of touch events by a system with one or more touch-based input devices—i.e., identifying one or more touch inputs by a user and determining corresponding touch event(s)—may be implemented by a combination of hardware, software, and/or firmware (or device drivers). FIG. 1 illustrates an example processing stack of a mobile device (e.g., a smart phone). In the example of FIG. 1, the mobile device may comprise hardware devices (120) such as Input-Output (I/O) devices (e.g., a touch screen, speakers, a light-emitting diode or LED indicator, a camera, etc.), communication interface devices (e.g., a cellular interface, a Wi-Fi interface), sensors (e.g., a Global Positioning System or GPS sensor, a proximity sensor, an accelerometer, etc.), and other hardware devices. One or more device drivers in driver layer 102 hosted by one or more processors 110 of the mobile device can communicate and control the hardware devices. One or more processors 110 can execute various software programs, for example, operating system 103 running one or more application programs (e.g., web browser, address book, etc.) in applications 105 and managing one or more hardware devices via the one or more device drivers in driver layer 102. Libraries 104 can include one or more libraries used by one or more application programs in applications 105. For example, the mobile device may comprise one or more device drivers communicating with one or more touch-based input devices and detecting touch inputs. The system may comprise a touch gesture library containing computer program code for interpreting touch inputs detected by the device drivers to touch events or gestures. A program running on the mobile device can detect and process touch events by subscribing as listeners to touch event modules in the touch gesture library.

In addition to alphabetical and numerical keys, a keyboard of a computing device often comprises one or more modifier keys or control keys—e.g., Shift key, Control or Ctrl key, Alternative or Alt key, Function keys (F1, F2, . . . ), etc.—that can change the operational mode of an interface such as the keyboard. When a user selects a control key, a user interface of an application hosted by the computing device, or an application user interface, can process the user's input based in part on the selected control key. For example, for a computer running a Microsoft Windows operating system, a user can enter a upper case letter at an application user interface with a hardware keyboard by holding down a Shift key while pressing an alphabetical key corresponding to the upper case letter. In many mobile devices, a user may first press the Shift key to lock the keyboard into the Shift mode for at least one subsequent keystroke. The user can also select an object (e.g., a text string, an image) in an application user interface and copy the selected object to a memory buffer (“clip board”) by pressing Control key and alphabetical “C” key at the same time. A user can perform a task by selecting more than one control keys, for example, a user can hold down Control, Alt, and Delete keys (“Ctrl-Alt-Del”) at the same time to bring up a task manager user interface. A user can also select one control key to perform a task. For example, in a user interface of Microsoft Word application, a user can press F1 function key to bring up a help menu user interface.

Particular embodiments herein relate to a mobile device (e.g., a mobile phone, a smart phone, a tablet, or other portable device) with a display disposed on a front side of the device and a touch surface disposed on a back side of the device. The back-side touch surface can improve user experience associated with the mobile device as the back-side touch surface can provide an additional area for user inputs. More particularly, the back-side touch surface can enable a user to select a mode corresponding to a control key for an application user interface by using touch input on the back-side touch surface. The front side display of the mobile device may also be a touch surface display. In some implementations, the keyboard of the mobile device is a virtual keyboard rendered by software in a touch-sensitive display. In other implementations, the keyboard may be a physical QWERTY-style keyboard.

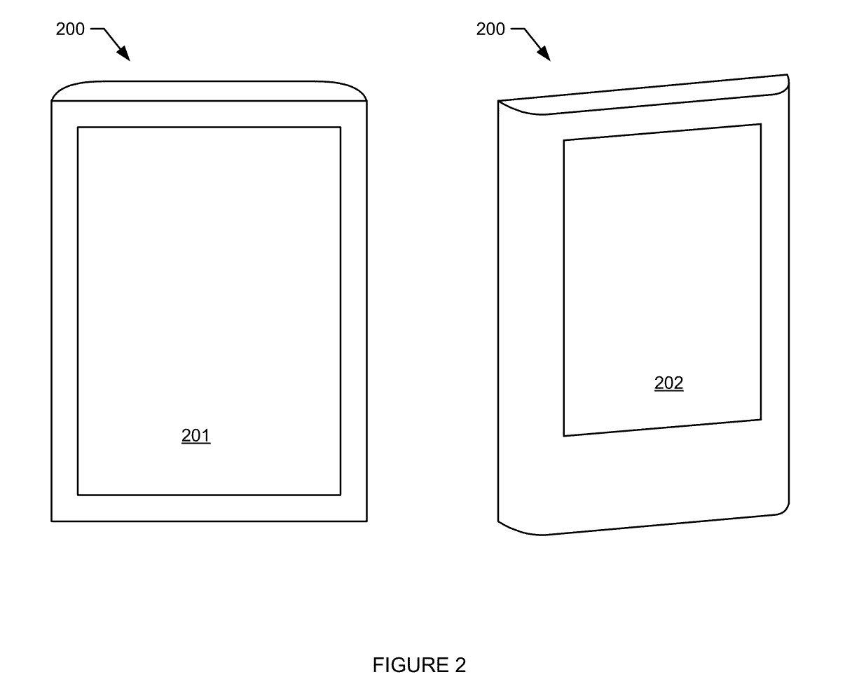

FIG. 2 illustrates an example mobile device. In the example of FIG. 2, mobile device 200 may comprise a housing with a display 201 disposed on a front side of the housing and a secondary touch surface 202 disposed on a back side of the housing. Touch surface 202 may be a single-touch, dual-touch, or multi-touch device. In some embodiments, display 201 may be a single-touch, dual-touch, or multi-touch display. In some embodiments, touch surface 202 may comprise a touch screen. Mobile device 200 may comprise a touch gesture library containing touch event modules or logic that can recognize touch inputs, and determine one or more corresponding touch events or gestures (e.g., tap, drag, swipe, pinch). On or more applications hosted by mobile device 200 may be configured to detect one or more touch events or gestures by subscribing as listeners to touch event modules in the touch gesture library. In particular embodiments, an application hosted by mobile device 200 may, in response to a touch event generated by back-side touch surface 202, select a control key mode for the application's user interface based on the touch event, and process one or more user inputs at the application user interface based in part on a mode corresponding to the selected control key mode.

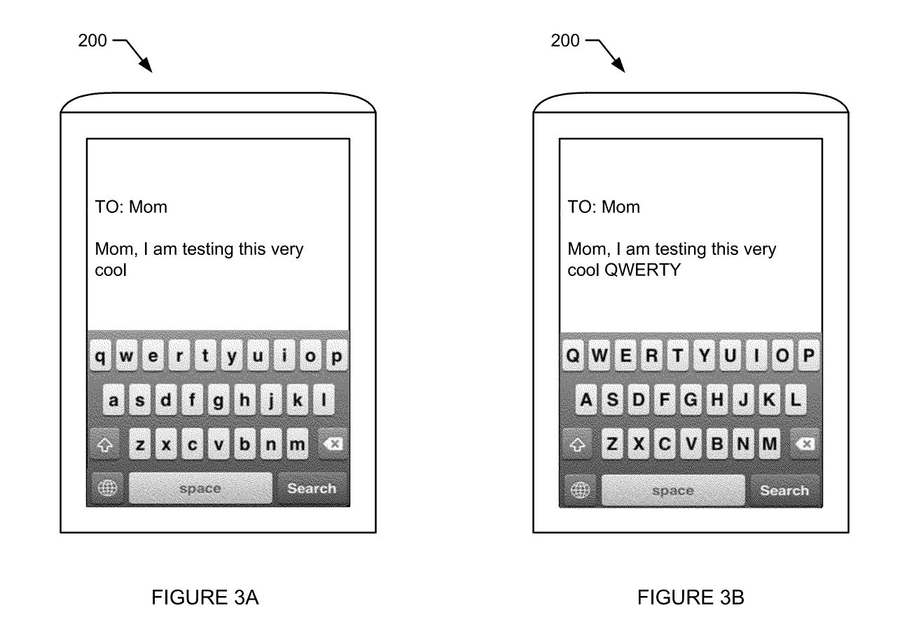

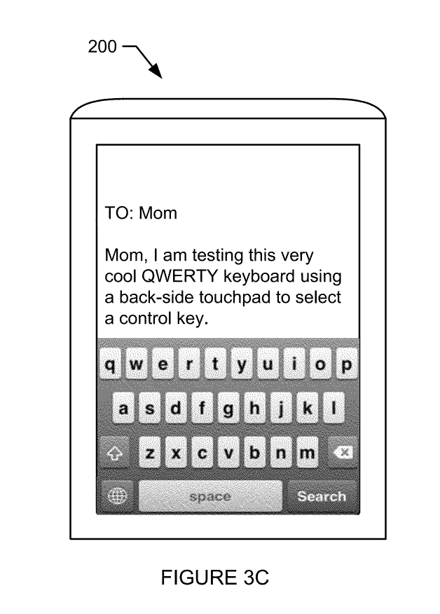

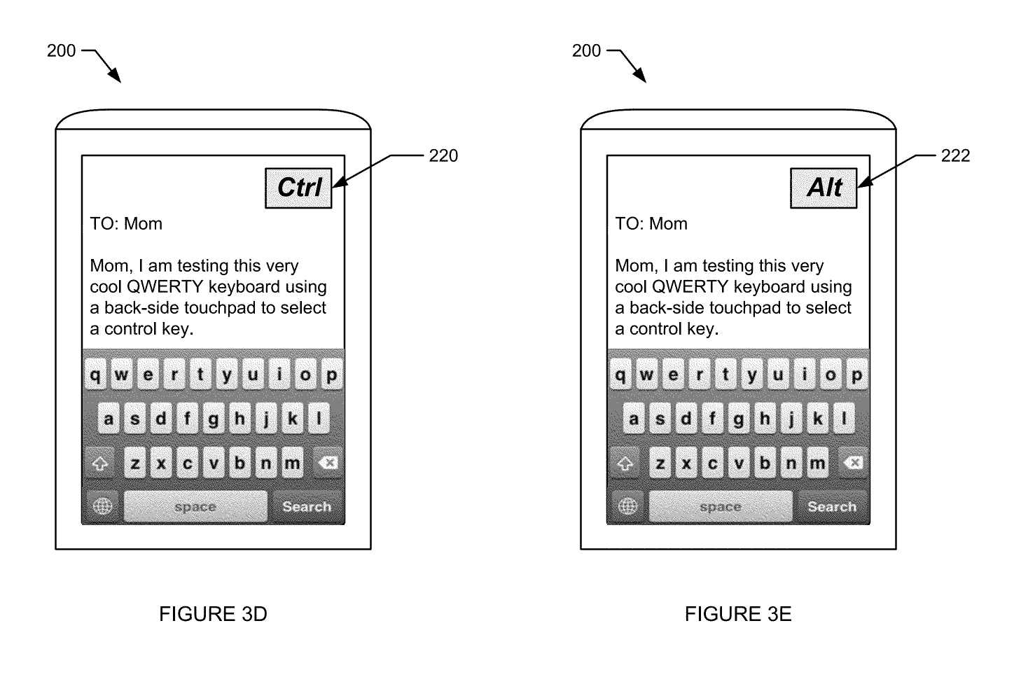

FIGS. 3A-3C illustrate an example of selecting a control key mode using touch input. FIGS. 3A-3C illustrates a user interface of an email application hosted by mobile device 200, wherein a user can enter an email message with a software keyboard of the user interface displayed in front-side touch screen 201. For example, the user may select a mode corresponding to the Shift key for the user interface by a single tap on back-side touch surface 202 with one finger. In particular embodiments, the email application may detect a single-finger, single-tap touch event on back-side touch surface 202, and process the next alphabetical character the user enters at the user interface as an upper case character. For example, the user may select or de-select a Shift-Lock mode (i.e., Caps Lock) by a double-tap on back-side touch surface 202 with one figure. In particular embodiments, the email application may detect a first single-finger, double-tap touch event on back-side touch surface 202, and process alphabetical characters the user enters at the user interface (displayed at front-side touch screen 201) as upper case characters, until the email application detects a second single-finger, double-tap touch event on back-side touch surface 202. Additionally, in particular embodiments, the email application may indicate the selection of Shift key mode (or Shift-Lock mode) in the user interface. In the example of FIG. 3A, the user enters an email message in lower-case using the software keyboard of the user interface displayed in front-side touch screen 201. The user can double-tap on back-side touch surface 202 with one finger, causing the email application to select Shift-Lock mode and process alphabetical characters the user enters following the single-finger, double-tap touch event as upper-case characters (e.g., “QWERTY”) and display the keyboard in upper-case alphabets, as illustrated in FIG. 3B. The user can then double-tap on back-side touch surface 202 with one finger, causing the email application to de-select Shift-Lock mode and process alphabetical characters the user enters following the second single-finger, double-tap touch event in lower-case characters and display the keyboard in lower-case alphabets, as illustrated in FIG. 3C.

FIGS. 3D and 3E illustrate additional examples of selecting a control key mode using touch input. As in the example of FIGS. 3A-3C, a user enters an email message in the user interface (displayed in front-side touch screen 201) of the email application hosted by mobile device 200. For example, the user may select the Control key by a single tap on back-side touch surface 202 with two fingers. In particular embodiments, the email application may detect a two-finger, single-tap touch event on back-side touch surface 202, and select a mode corresponding to the Control key for the user interface. The email application may indicate the selection of the Control key mode by displaying an icon 220 in the user interface, as illustrated in FIG. 3D. For example, the user may select the Alt key by a single tap on back-side touch surface 202 with three fingers. In particular embodiments, the email application may detect a three-finger, single-tap touch event on back-side touch surface 202, and select a mode corresponding to the Alt key for the user interface. The email application may indicate the selection of the Alt key mode by display an icon 222 in the user interface, as illustrated in FIG. 3E.

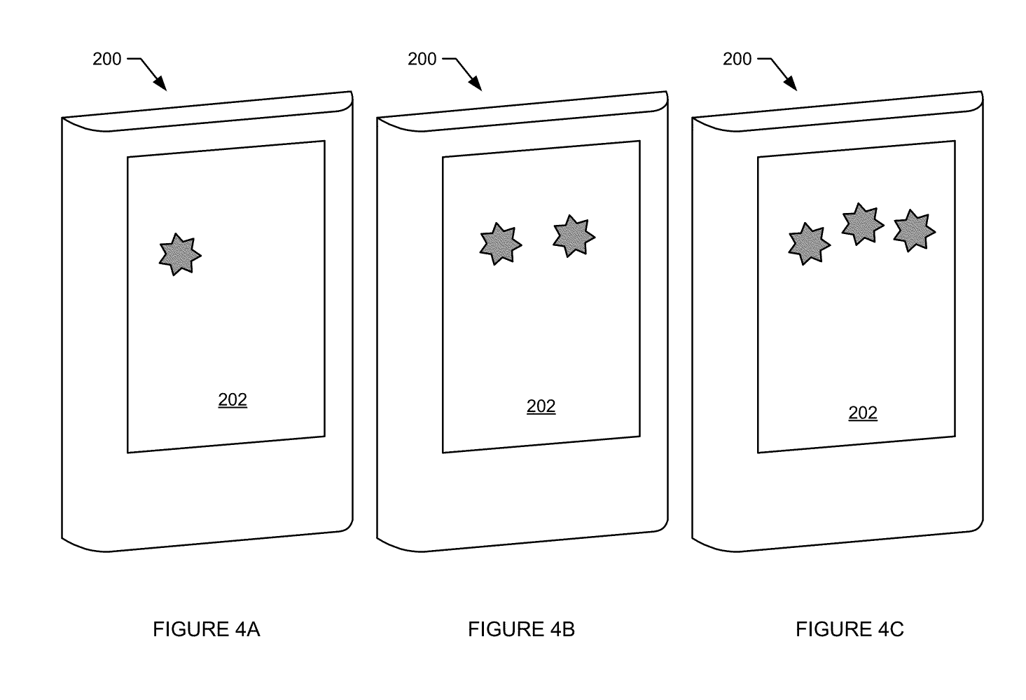

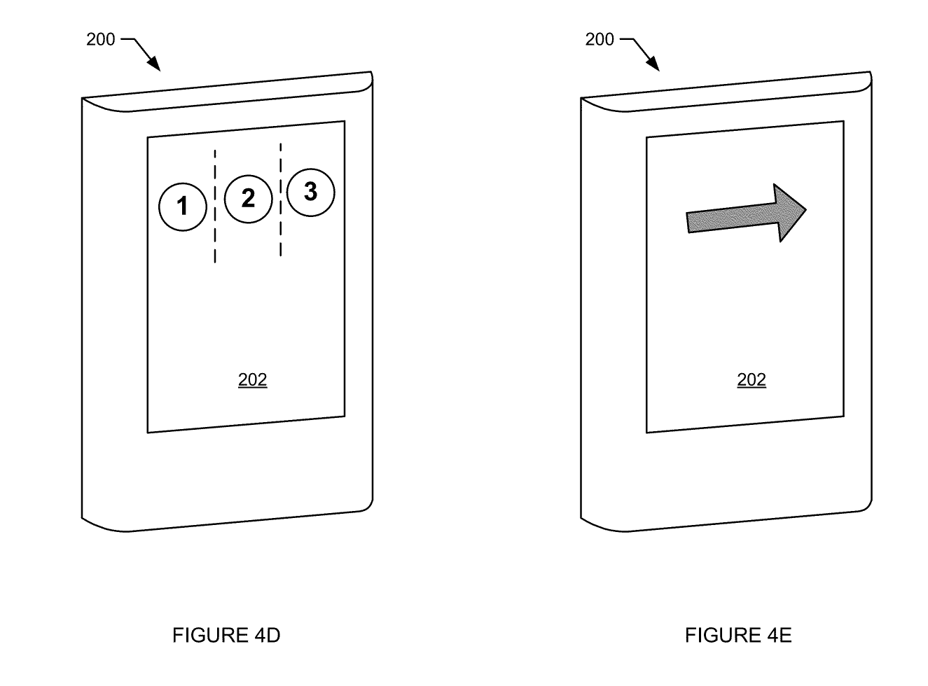

As illustrated above, a user of an application user interface may select control key modes using different touch gestures on back-side touch surface 202. FIGS. 4A-4E illustrate example touch gestures for selecting control key modes. As illustrated in FIGS. 3A-3E, a user of an email application hosted by mobile device 200 may select a Shift key mode with a single-finger, single-tap touch gesture on back-side touch surface 202 (as illustrated in FIG. 4A), select a Control key mode with a double-finger, single-tap touch gesture on back-side touch surface 202 (as illustrated in FIG. 4B), or select a Alt key mode with a three-finger, single-tap touch gesture on back-side touch surface 202 (as illustrated in FIG. 4C). In other embodiments, a user may select a control key mode based on a location of a touch input, as illustrated in FIG. 4D. In particular embodiments, mobile device 200 may identify a location of a touch event based on a plurality of zones dividing touch surface 202. For example, touch surface 202 may be divided into three zones (zone 1 to zone 3 as illustrated in FIG. 4D), while a touch gesture library of mobile device 200 can interpret a touch input with a location corresponding to one of the three zones. In other words, a touch input with a position anywhere within a given region or zone is classified and processed similarly. For example, the email application described above may detect a touch event on back-side touch surface 202, and select a mode corresponding to the Shift key based on a touch event corresponding to a single tap within zone 1, select a mode corresponding to the Control key based on a touch event corresponding to a single tap within zone 2, or select a mode corresponding to the Alt key based on a touch event corresponding to a single tap within zone 3. Furthermore, the user may select more than one control key at the same time—e.g., the user may tap within zone 1 and tap within zone 2 at the same time or consecutively, causing the email application to select modes corresponding to the Shift key and Control key at the same time. In one embodiment, the email application may detect a particular touch event on back-side touch surface 202, and cancel all selected Control key modes. For example, the email application may cancel all selected control key modes based on a swiping touch event on back-side touch surface 202, as illustrated in FIG. 4E.

In particular embodiments, a different application hosted by mobile device 200, when detecting a similar touch event on touch surface 202, may select a different control key mode for the application's user interface. For example, the email application described above may select a mode corresponding to the Shift key based on a single-finger, single-tap touch event, select a mode corresponding to the Control key based on a double-finger, single-tap touch event, or select a mode corresponding to the Alt key based on a three-finger, single-tap touch event. A web browser application hosted by mobile device 200 may select a mode corresponding to the Control key based on a single-finger, single-tap touch event, select a mode corresponding to the Shift key based on a double-finger, single-tap touch event, or may cancel modes corresponding to selected control keys based on a three-finger, single-tap touch event. A user of mobile device 200 may use other touch gestures on back-side touch-surface 202 to cause an application hosted by mobile device 200 to select a control key mode. For example, the email application described above may select a Shift-Lock mode based on a single-finger, press-and-hold touch event (e.g., a user can press one finger on touch surface 202 and hold for a threshold period of time like one second), select a Control+Shift mode based on a double-finger, press-and-hold touch event, or select a Alt+Shift mode based on a three-finger, press-and-hold touch event. For example, the email application may select the Shift-Lock mode based on a press-and-hold touch event within zone 1 of touch surface 202 (as illustrated in FIG. 4D), select the Control+Shift mode based on a press-and-hold touch event within zone 2 of touch surface 202, or select the Alt+Shift mode based on a press-and-hold touch event within zone 3 of touch surface 202. Other touch gestures may also used by a user to select control key modes—e.g., a swipe touch gesture, a “U” touch gesture, a “B” touch gesture, etc.

Additionally, an application hosted by mobile device 200 may select other operational modes for the application's user interface based on touch events on touch surface 202. For example, the email application described above may detect a double-tap touch event within zone 1 of touch surface 202, select a underline-style mode, and process the next character a user enters at the email application's user interface as an underlined character. For example, the email application may detect a double-tap touch event within zone 2 of touch surface 202, select a bold-style mode, and process the next character a user enters at the user interface in bold font. For example, the email application may detect a double-tap touch event within zone 3 of touch surface 202, select an italic-style mode, and process the next character a user enters at the user interface in italic font. In another embodiment, an application hosted by mobile device 200 may select language input method modes for the application's user interface based on touch events on touch surface 202. For example, the email application described above may detect a single-tap event within zone 1 of touch surface 202, select a Chinese input method (e.g., stroke count method), display a corresponding keyboard in the email application's user interface, and process the next one or more keys a user enters at the user interface as Chinese characters. For example, a user can single-tap within zone 1 of touch surface 202 multiple times, causing the email application to cycle through several language input method modes (e.g., Chinese pingyin input method, Japanese kana input method, English, Chinese pingyin input method, etc.). For example, the email application may detect a single-tap touch event within zone 3 of touch surface 202, and modify a character just entered at the email application's user interface with a diacritic mark. For example, a user may enter “cafe” in the user interface, and single-tap within zone 3 of touch surface 202, causing the email application to add an acute accent to the last character just entered by the user (e.g., “café”).

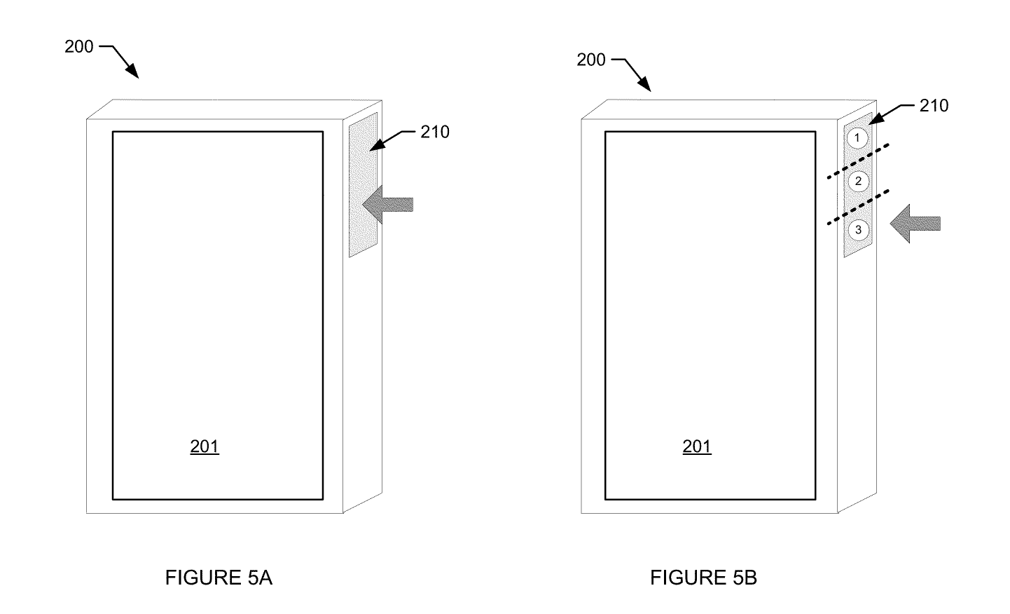

FIGS. 5A and 5B illustrates mobile device 200 with a secondary touch surface 210 disposed on a lateral side of the housing. In particular embodiments, an application hosted by mobile device 200 may, in response to a touch event generate by the side-mounted touch surface 210, select a control key mode for the application's user interface based on the touch event, and process one or more user inputs at the application user interface based in part on a mode corresponding to the selected control key mode. For example, a user of the email application described earlier may select a Shift key mode with a single-tap touch gesture on side-mounted touch surface 210 (as illustrated in FIG. 5A), select a Control key mode with a double-tap touch gesture on side-mounted touch surface 210, or select a Alt key mode with a triple-tap touch gesture on side-mounted touch surface 210. In other embodiments, a user may select a control key mode based on a location of a touch input, as illustrated in FIG. 5B. Mobile device 200 may identify a location of a touch event based on a plurality of zones dividing side-mounted touch surface 210 (e.g., zone 1 to zone 3), while a touch gesture library of mobile device 200 can interpret a touch input with a location corresponding to one of the three zones. In other words, a touch input with a position anywhere within a given region or zone is classified and processed similarly. For example, the email application described earlier may detect a touch event on side-mounted touch surface 210, and select a mode corresponding to the Shift key based on a touch event corresponding to a single tap within zone 1, select a mode corresponding to the Control key based on a touch event corresponding to a single tap within zone 2, or select a mode corresponding to the Alt key based on a touch event corresponding to a single tap within zone 3. Furthermore, for example, the email application may select a Shift-Lock mode based on a press-and-hold touch event within zone 1 of side-mounted touch surface 210, select the Control+Shift mode based on a press-and-hold touch event within zone 2 of side-mounted touch surface 210, or select the Alt+Shift mode based on a press-and-hold touch event within zone 3 of side-mounted touch surface 210.

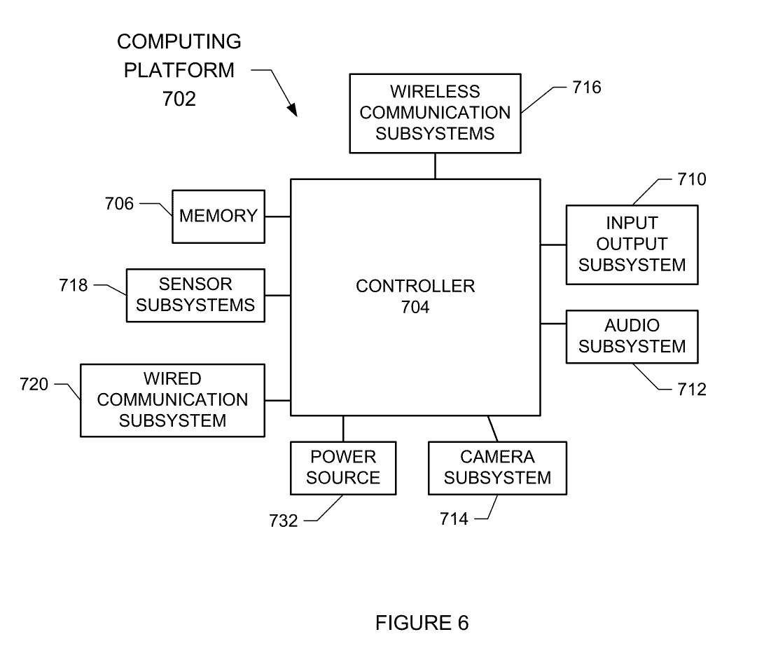

The touch event processing and control key mode selection functionality described above can be implemented as a series of instructions stored on a computer-readable storage medium that, when executed, cause a programmable processor to implement the operations described above. While the mobile device may be implemented in a variety of different hardware and computing systems, FIG. 6 shows a schematic representation of the main components of an example computing platform of a client or mobile device, according to various particular embodiments. In particular embodiments, computing platform 702 may comprise controller 704, memory 706, and input output subsystem 710. In particular embodiments, controller 704 which may comprise one or more processors and/or one or more microcontrollers configured to execute instructions and to carry out operations associated with a computing platform. In various embodiments, controller 704 may be implemented as a single-chip, multiple chips and/or other electrical components including one or more integrated circuits and printed circuit boards. Controller 704 may optionally contain a cache memory unit for temporary local storage of instructions, data, or computer addresses. By way of example, using instructions retrieved from memory, controller 704 may control the reception and manipulation of input and output data between components of computing platform 702. By way of example, controller 704 may include one or more processors or one or more controllers dedicated for certain processing tasks of computing platform 702, for example, for 2D/3D graphics processing, image processing, or video processing.

Controller 704 together with a suitable operating system may operate to execute instructions in the form of computer code and produce and use data. By way of example and not by way of limitation, the operating system may be Windows-based, Mac-based, Unix Linux-based, Android-based, or Symbian-based, among other suitable operating systems. The operating system, other computer code and/or data may be physically stored within memory 706 that is operatively coupled to controller 704.

Memory 706 may encompass one or more storage media and generally provide a place to store computer code (e.g., software and/or firmware) and data that are used by computing platform 702. By way of example, memory 706 may include various tangible computer-readable storage media including Read-Only Memory (ROM) and/or Random-Access Memory (RAM). As is well known in the art, ROM acts to transfer data and instructions uni-directionally to controller 704, and RAM is used typically to transfer data and instructions in a bi-directional manner. Memory 706 may also include one or more fixed storage devices in the form of, by way of example, hard disk drives (HDDs), solid-state drives (SSDs), flash-memory cards (e.g., Secured Digital or SD cards, embedded MultiMediaCard or eMMD cards), among other suitable forms of memory coupled bi-directionally to controller 704. Information may also reside on one or more removable storage media loaded into or installed in computing platform 702 when needed. By way of example, any of a number of suitable memory cards (e.g., SD cards) may be loaded into computing platform 702 on a temporary or permanent basis.

Input output subsystem 710 may comprise one or more input and output devices operably connected to controller 704. For example, input output subsystem may include keyboard, mouse, one or more buttons, thumb wheel, and/or, display (e.g., liquid crystal display (LCD), light emitting diode (LED), Interferometric modulator display (IMOD), or any other suitable display technology). Generally, input devices are configured to transfer data, commands and responses from the outside world into computing platform 702. The display is generally configured to display a graphical user interface (GUI) that provides an easy to use visual interface between a user of the computing platform 702 and the operating system or application(s) running on the mobile device. Generally, the GUI presents programs, files and operational options with graphical images. During operation, the user may select and activate various graphical images displayed on the display in order to initiate functions and tasks associated therewith. Input output subsystem 710 may also include touch based devices such as touch pad and touch screen. A touchpad is an input device including a surface that detects touch-based inputs of users. Similarly, a touch screen is a display that detects the presence and location of user touch inputs. Input output system 710 may also include dual touch or multi-touch displays or touch pads that can identify the presence, location and movement of more than one touch inputs, such as two or three finger touches.

In particular embodiments, computing platform 702 may additionally comprise audio subsystem 712, camera subsystem 712, wireless communication subsystem 716, sensor subsystems 718, and/or wired communication subsystem 720, operably connected to controller 704 to facilitate various functions of computing platform 702. For example, Audio subsystem 712, including a speaker, a microphone, and a codec module configured to process audio signals, can be utilized to facilitate voice-enabled functions, such as voice recognition, voice replication, digital recording, and telephony functions. For example, camera subsystem 712, including an optical sensor (e.g., a charged coupled device (CCD), or a complementary metal-oxide semiconductor (CMOS) image sensor), can be utilized to facilitate camera functions, such as recording photographs and video clips. For example, wired communication subsystem 720 can include a Universal Serial Bus (USB) port for file transferring, or a Ethernet port for connection to a local area network (LAN). Additionally, computing platform 702 may be powered by power source 732.

Wireless communication subsystem 716 can be designed to operate over one or more wireless networks, for example, a wireless PAN (WPAN) (such as, for example, a BLUETOOTH WPAN, an infrared PAN), a WI-FI network (such as, for example, an 802.11a/b/g/n WI-FI network, an 802.11s mesh network), a WI-MAX network, a cellular telephone network (such as, for example, a Global System for Mobile Communications (GSM) network, an Enhanced Data Rates for GSM Evolution (EDGE) network, a Universal Mobile Telecommunications System (UMTS) network, and/or a Long Term Evolution (LTE) network).

Sensor subsystem 718 may include one or more sensor devices to provide additional input and facilitate multiple functionalities of computing platform 702. For example, sensor subsystems 718 may include GPS sensor for location positioning, altimeter for altitude positioning, motion sensor for determining orientation of a mobile device, light sensor for photographing function with camera subsystem 714, temperature sensor for measuring ambient temperature, and/or biometric sensor for security application (e.g., fingerprint reader). Other input/output devices may include an accelerometer that can be used to detect the orientation of the device. In particular embodiments, various components of computing platform 702 may be operably connected together by one or more buses (including hardware and/or software). Additionally, computing platform 702 may be powered by power source 732.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a MultiMediaCard (MMC) card, an embedded MMC (eMMC) card, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. An apparatus of a first user, comprising:
a device housing;
a memory;
one or more main processors;
one or more sensors;
a first display disposed on a front side of the device housing;
a touch surface disposed on a back side of the device housing;
a program comprising computer-readable instructions operative, when executed, to cause the one or more processors to:
in response to a touch event generated by the touch surface during presentation of an application user interface at the first display:
select a control key mode for the application user interface based on the touch event; and
process one or more user inputs at the application user interface based in part on the selected control key mode.

2. The apparatus of claim 1, wherein to select a control key mode for the application user interface based on the touch event, the program further comprises computer readable instructions operative to cause the one or more processors to:
select a control key mode for the application user interface based on one or more locations of the touch surface corresponding to the touch event.

3. The apparatus of claim 1, wherein to select a control key mode for the application user interface based on the touch event, the program further comprises computer readable instructions operative to cause the one or more processors to:
select a control key mode for the application user interface based on a number of touches to the touch surface of the touch event.

4. The apparatus of claim 1, wherein to select a control key mode for the application user interface based on the touch event, the program further comprises computer readable instructions operative to cause the one or more processors to:
select a control key mode for the application user interface based on duration of contact to the touch surface of the touch event.

5. The apparatus of claim 2, wherein the program further comprises computer readable instructions operative to cause the one or more processors to:
indicating in the application user interface a selection of one or more control key modes.

6. An apparatus of a first user, comprising:
a device housing;
a memory;
one or more main processors;
one or more sensors;
a first display disposed on a front side of the device housing;
a touch surface disposed on a lateral side of the device housing;
a program comprising computer-readable instructions operative, when executed, to cause the one or more processors to:
in response to a touch event generated by the touch surface during presentation of an application user interface at the first display:
select a control key mode for the application user interface based on the touch event; and
process one or more user inputs at the application user interface based in part on the selected control key mode.

7. The apparatus of claim 6, wherein to select a control key mode for the application user interface based on the touch event, the program further comprises computer readable instructions operative to cause the one or more processors to:
select a control key mode for the application user interface based on one or more locations of the touch surface corresponding to the touch event.

8. The apparatus of claim 6, wherein to select a control key mode for the application user interface based on the touch event, the program further comprises computer readable instructions operative to cause the one or more processors to:
select a control key mode for the application user interface based on a number of touches to the touch surface of the touch event.

9. The apparatus of claim 6, wherein to select a control key mode for the application user interface based on the touch event, the program further comprises computer readable instructions operative to cause the one or more processors to:
select a control key mode for the application user interface based on duration of contact to the touch surface of the touch event.

10. The apparatus of claim 7, wherein the program further comprises computer readable instructions operative to cause the one or more processors to:
indicating in the application user interface a selection of one or more control key modes.
